(19) United States
(12) Patent Application Publication
(10) Pub. No.: US 2012/0158237 A1
(43) Pub. Date: Jun. 21, 2012

(54) UNMANNED APPARATUS AND METHOD OF DRIVING THE SAME

(75) Inventors: Meong-Hun LEE, Daejeon (KR); Yoon Ju LEE, Daejeon (KR)

(73) Assignee: ELECTRONICS AND TELECOMMUNICATIONS RESEARCH INSTITUTE, Daejeon (KR)

(21) Appl. No.: 13/329,830

(22) Filed: Dec. 19, 2011

(30) Foreign Application Priority Data
Dec. 20, 2010 (KR) 10-2010-0130784
May 11, 2011 (KR) 10-2011-0044225

(51) Int. Cl. G05D 1/00

(52) U.S. Cl. 701/26

(57) ABSTRACT

An unmanned apparatus obtains position information and communication quality and traffic information while traveling, synchronizes the position information with the communication quality and traffic information, maps the communication quality and traffic information for each poison, synchronized with the position information, to geographical information, displays the geographical information on an electronic map, and sets a traveling path using the electronic map.

### CROSS-REFERENCE TO RELATED APPLICATION

This application claims priority to and the benefit of Korean Patent Application Nos. 10-2010-0130784 and 10-2011-0044225 filed in the Korean Intellectual Property Office on Dec. 20, 2010 and May 11, 2011, the entire contents of which are incorporated herein by reference.

### BACKGROUND OF THE INVENTION

(a) Field of the Invention

The present invention relates to an unmanned apparatus and a method of driving the same. More particularly, the present invention relates to a method of setting a traveling path so that tasks can be performed quickly and accurately in an optimum communication environment.

(b) Description of the Related Art

Constant research is carried out on an unmanned system in order to be applied to prevention of disasters, facility surveillance, reconnaissance, and national defense.

When the unmanned system sends an event generated during an operation, such as observation or reconnaissance, to an operator, the operator handles the event by dispatching or controlling the unmanned system remotely. Here, if information needs to be transferred between the unmanned system and the operator in real time, seamless communication connection must be guaranteed for reliability and stability of the unmanned system. If real-time communication connection is impossible, the information must be transferred in the form of an ex post facto report, after a task is completed or after the unmanned system moves to an area where communication is possible.

A communication method used in the unmanned system, such as a reconnaissance plane, an unmanned ground autopilot system, and an autonomous traveling apparatus, is different according to an operation range and a mission.

The unmanned system chiefly uses a robot in the expansion aspect of an observation range and in the autonomous situation handling aspect. When the unmanned robot enters a communication shadow area, a communication failure is generated or traffic throughput is reduced because the unmanned robot is commonly operated in a remote place. Consequently, information, such as images, is not smoothly transmitted.

A program for automatically switching the unmanned robot to an emergency mode when a communication failure or a system error occurs so that the unmanned robot can safely return to a specific point is installed in the unmanned robot. However, a lot of danger may be generated if the unmanned robot is autonomously moved in a poor communication quality state.

Furthermore, a conventional GPS (Global Positioning System) or DGPS (Differential Global Positioning System) used to detect the position receives signals from satellites through a GPS receiver and measures current geographical coordinates. The GPS or the DGPS is being applied to various fields, such as aircraft operations, measurement, military applications, leisure, vehicle navigation, and traffic information display. The GPS is based on the principle that the terrestrial GPS receiver receives radio signals from 204 artificial satellites operated at an altitude of about 20,183 km and determines a current position by calculating a time difference between the radio signals received from the respective artificial satellites. A commercial GPS receiver has a maximum error of 100 m, commonly, a coordinate error of 30 m or less.

However, if the radio signals are weak or cannot be received, the GPS receiver is problematic in that it is difficult to detect an accurate position because the GPS receiver detects a current position by receiving the radio signals from the artificial satellites. That is, during the time for which the unmanned robot travels underground or travels through an area where skyscrapers are crowded, the satellite signals are subjected to interference and blocked. Consequently, a position where the unmanned robot is actually placed does not coincide with a position where the unmanned robot is displayed on the map.

### SUMMARY OF THE INVENTION

The present invention has been made in an effort to provide an unmanned apparatus and a method of driving the same, having advantages of enabling safe transfer of information and communication between the unmanned apparatus and an operator.

According to an exemplary embodiment of the present invention, there is provided an unmanned apparatus for performing tasks while traveling. The unmanned apparatus includes an information providing apparatus and a traveling apparatus. The information providing apparatus obtains communication quality and traffic information while transmitting and receiving a control signal and a data signal, obtains the position of the unmanned apparatus according to a movement, maps the communication quality and traffic information for each position to geographical information, and displays the geographical information on an electronic map. Furthermore, the traveling apparatus sets a traveling path using the electronic map on which the communication quality and traffic information for each position is displayed.

The traveling apparatus may set the traveling path based on the past traveling information and change the traveling path based on the communication quality and traffic information for each position.

Furthermore, the traveling apparatus may exclude a position, having a communication state less than a predetermined reference value, from the traveling path based on the communication quality and traffic information.

According to another exemplary embodiment of the present invention, there is provided a method of driving a moving unmanned apparatus. The method includes the steps of obtaining communication quality and traffic information about a communication signal according to a relevant communication method while transmitting and receiving a control signal and a data signal, obtaining the position of the unmanned apparatus according to a movement, synchronizing the communication quality and traffic information with each position, mapping the communication quality and traffic information for each position to geographical information and displaying the geographical information on an electronic map, and setting the traveling path using the electronic map on which the communication quality and traffic information for each position is displayed.

According to exemplary embodiments of the present invention, a traveling path is set using communication quality and traffic information for each point based on accurate position information. Accordingly, a task can be performed quickly and accurately in an optimum communication environment. Furthermore, control and gathering information of an unmanned apparatus can be safely transferred to an operator.

### BRIEF DESCRIPTION OF THE DRAWINGS

FIG. 1 is a diagram showing an unmanned apparatus according to an exemplary embodiment of the present invention;

FIG. 2 is a diagram showing a method of measuring communication quality and traffic information which is performed by a communication unit of FIG. 1;

FIG. 3 is a diagram showing a method of obtaining position information which is performed by a position detection unit of FIG. 1;

FIG. 4 is a diagram showing the operation of a controller shown in FIG. 1; and

FIG. 5 is a diagram showing a method of driving a traveling apparatus shown in FIG. 1.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification and claims, unless explicitly described to the contrary, the word “comprise” and variations such as “comprises” or “comprising”, will be understood to imply the inclusion of stated elements but not the exclusion of any other elements.

An unmanned apparatus and a method of driving the same according to exemplary embodiments of the present invention are described in detail with reference to the accompanying drawings.

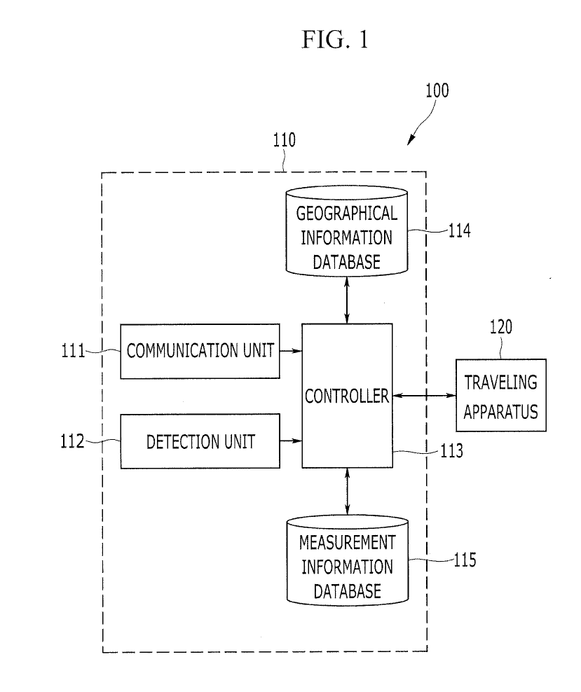

FIG. 1 is a diagram showing an unmanned apparatus according to an exemplary embodiment of the present invention.

In FIG. 1, the unmanned apparatus 100 may be an unmanned robot, and it is a machine for performing tasks automatically and manually. The machine refers to a machine which is capable of a target task or mission at a remote place, irrespective of the shape and size and operating ranges, such as operations on the ground, on the sea, in the water, and in the air.

Referring to FIG. 1, the unmanned apparatus 100 includes an information providing apparatus 110 and a traveling apparatus 120.

The information providing apparatus 110 measures remote communication and a position in an area where the unmanned apparatus 100 is operated and displays communication quality and traffic information in each position on an electronic map.

The traveling apparatus 120 drives the unmanned apparatus 100 based on the information received from the information providing apparatus 110. Particularly, the traveling apparatus 120 sets a traveling path to a destination by using the electronic map on which the communication quality and the traffic information are displayed.

The information providing apparatus 110 includes a communication unit 111, a position detection unit 112, a controller 113, a geographical information database 114, and a measurement information database 115.

The communication unit 111 performs communication in accordance with communication methods, such as a wired communication method and a wireless communication method, obtains communication quality and traffic information for a communication signal according to a relevant communication method while transmitting and receiving an unmanned apparatus control signal and a data signal, and transfers the obtained communication quality and traffic information to the controller 113. Here, the communication quality and traffic information may include signal strength, throughput, and an error rate in communication. Furthermore, the communication unit 111 performs a function of providing a user with control and remote monitoring information about the unmanned apparatus 100.

The position detection unit 112 can obtain the position of the unmanned apparatus 100 based on satellite signals received from artificial satellites and may also obtain the position of the unmanned apparatus 100 using internal sensors, such as a geomagnetic sensor, an acceleration sensor, a steering angle sensor, a gyro sensor, and a gravity sensor. The position detection unit 112 transfers the position information of the unmanned apparatus 100 to the controller 113.

The controller 113 synchronizes the communication quality and traffic information, received from the communication unit 111, with the position information received from the position detection unit 112, maps communication quality and traffic information in each position to geographical information, and displays the geographical information on an electronic map corresponding to an area where the unmanned apparatus 100 is operated. That is, the controller 113 displays communication quality and traffic information for each point on the electronic map based on the position received from the position detection unit 112 and stores the communication quality and traffic information for each point in the measurement information database 115.

Furthermore, the controller 113 transfers the electronic map on which the communication quality and traffic information for each point is displayed to the traveling apparatus 120.

The geographical information database 114 stores an electronic map written based on actual area information. Particularly, the geographical information database 114 stores an electronic map on which geographical information, corresponding to an area where the unmanned apparatus 100 is operated, is displayed.

The measurement information database 115 stores communication quality and traffic information for each position of an area where the unmanned apparatus 100 is operated or an electronic map on which the communication quality and traffic information for each position is displayed or both.

The traveling apparatus 120 controls the driving of the unmanned apparatus 100 automatically and manually based on the electronic map on which the communication quality and traffic information for each point, received from the controller 113, is displayed.

Furthermore, the traveling apparatus 120 sets the traveling path of the unmanned apparatus 100 using the electronic map on which the communication quality and traffic information for each point is displayed. Here, the traveling apparatus 120 may avoid communication shadow areas and set a traveling path along which a destination can be reached in an optimum communication environment. That is, if a communication state is determined not to be good based on current communication quality and traffic information, the traveling apparatus 120 sets a relevant area as a communication shadow area and does not travel through the relevant area.

Accordingly, the unmanned apparatus 100 can travel in a stable communication environment and can stably transfer information, gathered in a task execution process, to an operator.

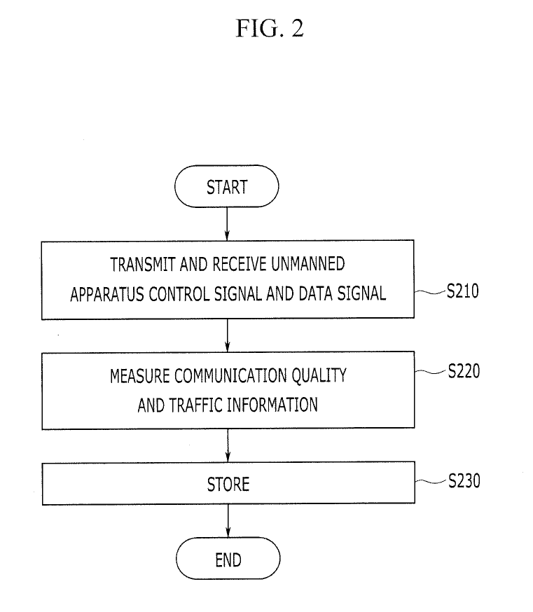

FIG. 2 is a diagram showing a method of measuring communication quality and traffic information which is performed by the communication unit of FIG. 1.

Referring to FIG. 2, when the unmanned apparatus 100 starts traveling, the communication unit 111 measures communication quality and traffic information about a communication signal according to each communication method while transmitting and receiving an unmanned apparatus control signal and a data signal at steps S210 and S220.

After the communication quality and traffic information is obtained as described above, the communication unit 111 transfers the communication quality and traffic information to the controller 113. The controller 113 stores the communication quality and traffic information in the measurement information database 114 at step S230.

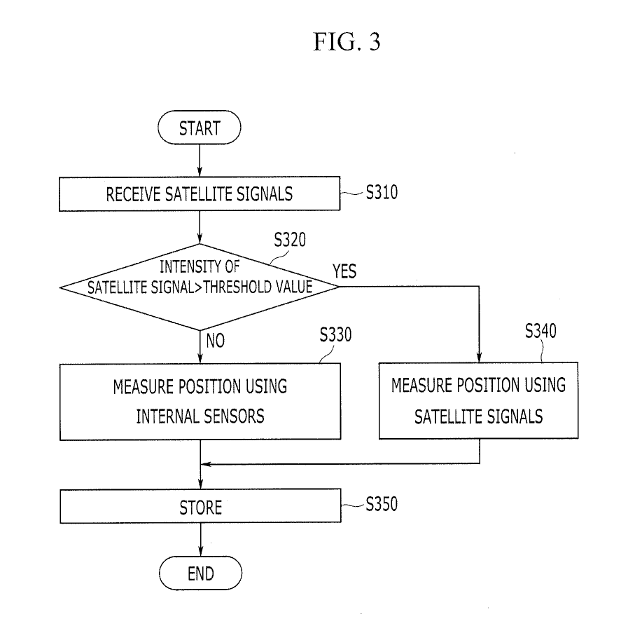

FIG. 3 is a diagram showing a method of obtaining position information which is performed by the position detection unit of FIG. 1.

Referring to FIG. 3, the position detection unit 112 receives satellite signals from artificial satellites at step S310. If the strength of the satellite signal is a threshold value or less at step S320, the position detection unit 112 measures the position of the unmanned apparatus 100 using the internal sensors at step S330. If the strength of the satellite signal is greater than the threshold value at step S320, the position detection unit 112 measures the position of the unmanned apparatus 100 by calculating the longitude and the latitude using the satellite signals at step S340.

The position detection unit 112 transfers the measured position information to the controller 113. The controller 113 stores the measured position information in the measurement information database 114 at step S350.

Even when a satellite signal is weak as described above or a satellite signal cannot be received, the position detection unit 112 can measure the position of the unmanned apparatus 100.

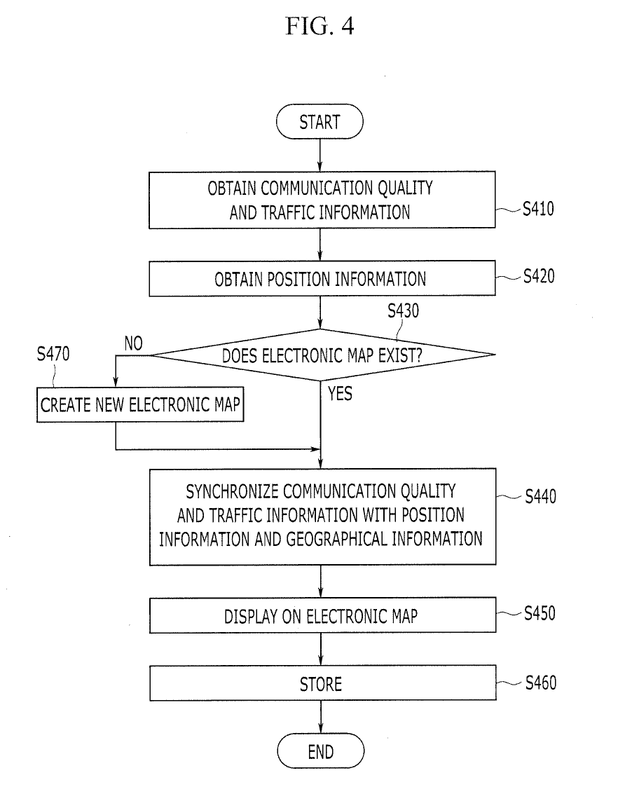

FIG. 4 is a diagram showing the operation of the controller shown in FIG. 1.

Referring to FIG. 4, when the unmanned apparatus 100 starts traveling, the controller 113 obtains communication quality and traffic information from the communication unit 111 at step S410. Furthermore, the controller 113 obtains position information about the unmanned apparatus 100 from the position detection unit 112 at step S420.

The controller 113 searches the geographical information database 114 for an electronic map corresponding to an area where the unmanned apparatus 100 is now traveling at step S430.

If, as a result of the search, there is an electronic map, corresponding to the area where the unmanned apparatus 100 is now traveling, in the geographical information database 114, the controller 113 synchronizes the position information with the communication quality and traffic information, maps the synchronized communication quality and traffic information for each position to geographical information, and displays the geographical information on the electronic map at step S440 and S450. The controller 113 stores the communication quality and traffic information for each position and information about the electronic map on which the communication quality and traffic information for each position is displayed in the measurement information database 115 at step S460. Alternatively, the information providing apparatus 110 may further include an image photographing unit (not shown) for photographing an image. In this case, the controller 113 may synchronize the photographed image with position information and displays the position information on a relevant electronic map.

Meanwhile, if, as a result of the search, there is no electronic map, corresponding to the area where the unmanned apparatus 100 is now traveling, in the geographical information database 114, the unmanned apparatus 100 creates a new electronic map based on real-time position information, obtained by the position detection unit 112, and communication quality and traffic information stored in the measurement information database 115 at step S470 and displays the communication quality and traffic information for each position which has been synchronized on the created electronic map at steps S440 and S450.

If the communication quality and traffic information for each position has already been stored in the measurement information database 115 when the communication quality and traffic information is stored, the controller 113 may update the communication quality and traffic information into the most recent information.

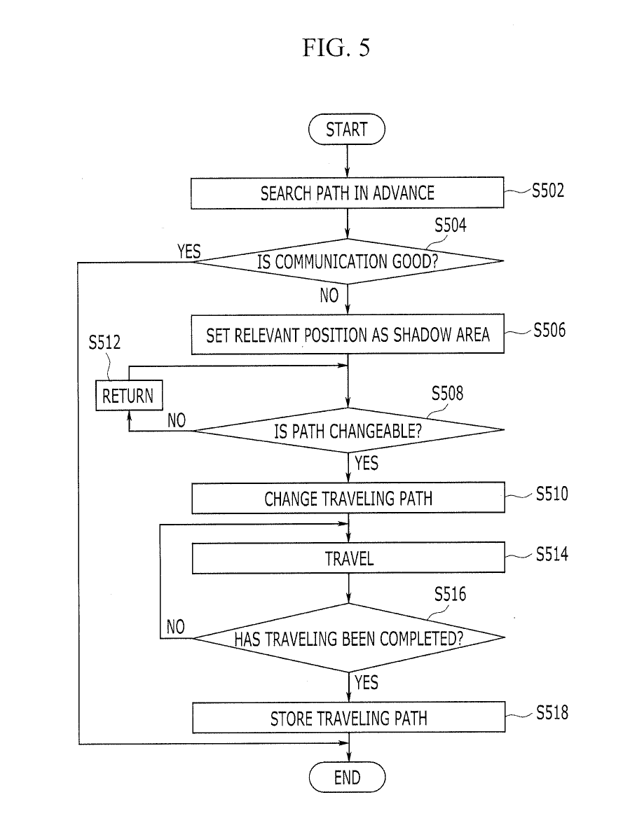

FIG. 5 is a diagram showing a method of driving the traveling apparatus shown in FIG. 1.

Referring to FIG. 5, before the unmanned apparatus 100 performs automatic and manual tasks, the traveling apparatus 120 searches an operation database (not shown) in advance at step S502. That is, the traveling apparatus 120 searches for a traveling path recorded in the past so that communication remains intact and a real-time operation is possible.

The traveling apparatus 120 sets a path before traveling based on traveling information stored in the operation database and corrects the set path based on communication quality and traffic information during autonomous traveling. More particularly, if communication at a current position is determined not to be good based on communication quality and traffic information during autonomous traveling at step S504, the traveling apparatus 120 sets the relevant position as a communication shadow area at step S506 so that the unmanned apparatus 100 does not travel through the relevant position. Here, if communication quality and traffic information is less than a predetermined reference value, the traveling apparatus 120 may determine that communication is not good. The reference value may be changed by an operator.

The traveling apparatus 120 determines whether the traveling path can be changed and, if, as a result of the determination, the traveling path can be changed, changes the traveling path at steps S508 and S510. If, as a result of the determination, the traveling path cannot be changed, the traveling apparatus 120 returns to a point just before a current point at step S512 and then determines whether the traveling path can be changed at step S508.

When changing the traveling path, the traveling apparatus 120 may use communication quality and traffic information or the operation database. Meanwhile, the traveling apparatus 120 may maintain communication connection by setting a traveling path based on communication quality and traffic information even in autonomous traveling in an area where preliminary search has not been performed. As described above, when the traveling apparatus 120 travels along a changed traveling path by changing the traveling path or travels along a predetermined path based on the past traveling information because communication is good at step S514, a relevant traveling path may be stored in the operation database after traveling is completed so that the relevant traveling path can be used for a subsequent traveling plan at step S516 and S518.

The exemplary embodiments of the present invention are not implemented only through the method or the apparatus or both, but may be implemented through a program for realizing a function corresponding to the construction according to the exemplary embodiment of the present invention or a recording medium on which the program is recorded. The implementations will be evident to those having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An unmanned apparatus for performing a task while traveling, the unmanned apparatus comprising:
an information providing apparatus for obtaining communication quality and traffic information while transmitting and receiving a control signal and a data signal, obtaining a position of the unmanned apparatus according to a movement, mapping the communication quality and traffic information for each position to geographical information, and displaying the geographical information on an electronic map; and
a traveling apparatus for setting a traveling path using the electronic map on which the communication quality and traffic information for each position is displayed.

2. The unmanned apparatus of claim 1, wherein the traveling apparatus sets the traveling path based on traveling information and changes the traveling path based on the communication quality and traffic information for each position.

3. The unmanned apparatus of claim 2, wherein the traveling apparatus excludes a position, having a communication state less than a predetermined reference value, from the traveling path based on the communication quality and traffic information.

4. The unmanned apparatus of claim 1, wherein the information providing apparatus further comprises a position detection unit for obtaining the position of the unmanned apparatus, and
the position detection unit obtains the position from satellite signals.

5. The unmanned apparatus of claim 4, wherein the position detection unit obtains the position of the unmanned apparatus using internal sensors when a strength of the satellite signal is a predetermined threshold value or less.

6. The unmanned apparatus of claim 1, further comprising a traveling database, wherein the traveling apparatus stores the traveling path in the traveling database after traveling.

7. A method of setting a traveling path when driving a moving unmanned apparatus, comprising the steps of:
obtaining communication quality and traffic information about a communication signal according to a relevant communication method while transmitting and receiving a control signal and a data signal;
obtaining a position of the unmanned apparatus according to a movement;
synchronizing the communication quality and traffic information with each position;
mapping the communication quality and traffic information for each position to geographical information and displaying the geographical information on an electronic map; and
setting the traveling path using the electronic map on which the communication quality and traffic information for each position is displayed.

8. The method of claim 7, wherein the step of obtaining the position of the unmanned apparatus according to the movement comprises the steps of:
receiving satellite signals;
when an strength of the satellite signal is greater than a threshold value, calculating the position from the satellite signal; and
when the strength of the satellite signal is the threshold value or less, calculating the position using internal sensors.

9. The method of claim 7, wherein the step of setting the traveling path comprises the steps of:
setting the traveling path based on past traveling information; and
changing the traveling path based on the communication quality and traffic information for each position.

10. The method of claim 9, wherein the step of changing the traveling path comprises the step of excluding a position, having a communication state less than a predetermined reference value, from the traveling path based on the communication quality and traffic information.

11. The method of claim 9, wherein the step of changing the traveling path comprises the step of returning to a position right before a position, having a communication state less than a predetermined reference value, based on the communication quality and traffic information if a traveling path to be changed does not exist in the position having the communication state less than the predetermined reference value.

12. The method of claim 7, further comprising the step of photographing an image while moving, wherein the step of synchronizing the communication quality and traffic information with each position comprises the step of synchronizing the image photographed at the position with the communication quality and traffic information.
